(19) United States
(12) Patent Application Publication
(10) Pub. No.: US 2013/0118631 A1
(43) Pub. Date: May 16, 2013

(54) DEVICE FOR MANUFACTURING PROFILE CORRUGATED TUBE, METHOD FOR MANUFACTURING PROFILE CORRUGATED TUBE AND PROFILE CORRUGATED TUBE

(71) Applicant: Keiji Itagaki, Yokkaichi-shi (JP)

(72) Inventor: Keiji Itagaki, Yokkaichi-shi (JP)

(73) Assignee: SUMITOMO WIRING SYSTEMS, LTD., Yokkaichi-shi, Mie (JP)

(21) Appl. No.: 13/809,168

(22) PCT Filed: Feb. 25, 2011
(86) PCT No.: PCT/JP2011/054344

§ 371 Date: Jan. 9, 2013

(30) Foreign Application Priority Data
Jul. 26, 2010 (JP) 2010-167007

(51) Int. Cl. B29D 23/00; F16L 9/00

(52) U.S. Cl. CPC B29D 23/001; F16L 9/00
USPC 138/173; 425/403; 264/295

(57) ABSTRACT

A device for manufacturing a flat profile corrugated tube includes a supplying portion for pushing out and supplying a molten resin material in the form of a sheet, a pair of metal molds for molding a profile corrugated tube, a driving mechanism portion capable of changing postures of the pair of metal molds into receiving postures in which the metal mold surfaces are opened and can receive a sheet-formed molded body supplied from the supplying portion and molding postures in which the metal mold surfaces are closed, and changing the postures of the pair of metal molds into the molding postures after the sheet-formed molded body supplied from the supplying portion is received in the receiving postures, and an adhesion molding portion for causing the sheet-formed molded body supplied from the supplying portion to adhere to the metal mold surfaces of the pair of metal molds taking the receiving postures.

### TECHNICAL FIELD

The present invention relates to a technique for manufacturing a profile corrugated tube.

### BACKGROUND ART

A device for manufacturing a corrugated tube is disclosed in Patent Document 1. A device for manufacturing a tube according to the Patent Document 1 has such a structure as to have plural pairs of molding blocks for forming an almost cylindrical molding space for manufacturing a tube by closing and to move the plural pairs of molding blocks over a non-end track to enable mold closing or mold opening. More specifically, a wall surface of the molding block takes a shape of bellows in which a diameter increasing portion concaved outward in a radial direction of the tube and a diameter reducing portion narrowed inward in the radial direction are alternately repeated in an axial direction. Moreover, a pair of molding blocks is brought into a mold closing state in which they are closed within a stroke range, and is brought into a mold opening state in which they are separated from each other in the other positions. A cylindrical molten resin is supplied from an inlet side of the stroke range into a space in which the pair of molding blocks are formed by means of an extruding machine, and furthermore, compressed air is supplied to an inner part thereof and enlargement and opening are carried out in such a manner that the molten resin sticks to the wall surface of the molding block.

### PRIOR ART DOCUMENT

### Patent Document

Patent Document 1: Japanese Patent Application Laid-Open No. 2000-343592

### SUMMARY OF THE INVENTION

### Problems to be Solved by the Invention

The corrugated tube manufactured as described above is used as an outer casing member for protecting a wire harness to be provided in a car in some cases. Depending on a shape of the wire harness to be a protecting target or a space of a place for disposition, a flat profile corrugated tube is also used in some cases. There is also assumed the case in which a shape having a high ratio of a long dimension to a short dimension in a section (which will be hereinafter referred to as an elongation ratio) is required for the profile corrugated tube.

In the device for manufacturing a corrugated tube, however, it is hard to manufacture a profile corrugated tube having a high elongation ratio. In other words, a resin material immediately after a supply into a metal mold (a molding block) tends to be deformed because it is supplied in a softening state brought immediately after a temperature is reduced in a melting state. Furthermore, the resin material has portions in the long direction seen on a section which are present with a small interval. For this reason, there is a fear that the portions might stick together by an influence of gravity and might not adhere to a metal mold surface.

Therefore, it is an object of the present invention to manufacture a flat profile corrugated tube having a high elongation ratio.

### Means for Solving the Problems

A first aspect is directed to a device for manufacturing a profile corrugated tube which serves to manufacture a flat profile corrugated tube, including a supplying portion for pushing out and supplying a molten resin in the form of a sheet, a pair of metal molds for molding a profile corrugated tube which include metal mold surfaces having corresponding portions to one side portion in a long direction seen on a section of the profile corrugated tube, respectively, a driving mechanism portion capable of changing postures of the pair of metal molds into a receiving posture in which the metal mold surfaces are opened and can receive a sheet-formed molded body supplied from the supplying portion and a molding posture in which the metal mold surfaces are closed, and changing the postures of the pair of metal molds into the molding postures after the sheet-formed molded body supplied from the supplying portion is received by the pair of metal molds taking the receiving postures, and an adhesion molding portion for causing the sheet-formed molded body supplied from the supplying portion to adhere to the metal mold surfaces of the pair of metal molds taking the receiving postures.

A second aspect is directed to the device for manufacturing a profile corrugated tube according to the first aspect, wherein the molding postures of the pair of metal molds are postures in which the respective metal mold surfaces form a predetermined interval in one of edge portions and are adjacent to each other in the other edge portion.

A third aspect is directed to the device for manufacturing a profile corrugated tube according to the first or second aspect, wherein the receiving postures of the pair of metal molds are postures in which the respective metal mold surfaces are turned upward and are adjacent to each other in the other edge portion.

A fourth aspect is directed to the device for manufacturing a profile corrugated tube according to any of the first to third aspects, wherein the supplying portion can continuously supply the sheet-formed molded body, and the driving mechanism portion moves the plural pairs of metal molds in series over a pair of non-end circular moving tracks respectively, and gradually changes the postures of the pair of metal molds from an upstream toward a downstream in order to cause the pair of metal molds to take the receiving posture in an upstream position of a predetermined tube molding path in the moving track through which the sheet-formed molded body is supplied from the supplying portion and to cause the pair of metal molds to take the molding posture in a downstream position of the tube molding path in the tube molding path.

A fifth aspect is directed to the device for manufacturing a profile corrugated tube according to any of the first to fourth aspects, wherein the driving mechanism portion includes a guided portion attached to each of the plural pairs of metal molds, a pair of guiding rails provided along the moving track and formed to take such a shape that the guided portion can be guided to change the postures of the pair of metal molds from the receiving postures to the molding postures over the tube molding path, and a feeding portion for feeding the plural pairs of metal molds so as to be moved from the upstream toward the downstream in the tube molding path respectively.

A sixth aspect is directed to a method for manufacturing a profile corrugated tube which serves to manufacture a flat profile corrugated tube, including the steps of (a) pushing out and supplying a molten resin in the form of a sheet, (b) molding the sheet-formed molded body supplied in step (a) into a shape in which the profile corrugated tube is broken and opened at one of ends in a long direction seen on a section, and (c) closing the molded body molded in step (b) and taking the shape in which the profile corrugated tube is broken and opened.

A seventh aspect is directed to a flat profile corrugated tube in which a dimension in a long direction seen on a section is set to be three times as large as a dimension in a short direction or more.

### Effect of the Invention

According to the device for manufacturing a profile corrugated tube in accordance with the first aspect, there is employed the structure in which the molten resin is pushed out and supplied in the form of the sheet by the supplying portion, and the sheet-formed molded body supplied from the supplying portion is received in the receiving posture and the postures of the pair of metal molds are then changed into the molding postures. Therefore, the sheet-formed molded body which tends to be deformed immediately after the supply can be prevented from being deformed and sticking together. Consequently, it is possible to manufacture a flat profile corrugated tube having a high elongation ratio.

According to the device for manufacturing a profile corrugated tube in accordance with the second aspect, the molding postures of the pair of metal molds are set to be postures in which the respective metal mold surfaces form a predetermined interval in one of the edge portions. Consequently, it is possible to manufacture a flat profile corrugated tube having a slit for accommodating a wire harness without providing a slit forming step separately.

According to the method for manufacturing a profile corrugated tube in accordance with the third aspect, the receiving postures of the pair of metal molds are set to be postures in which the respective metal mold surfaces are turned upward. Therefore, the sheet-formed molded body to be supplied onto the pair of metal molds taking the receiving postures from the supplying portion can be prevented from being separated from the metal mold surfaces. Consequently, it is possible to manufacture a flat profile corrugated tube having a high elongation ratio more reliably.

According to the device for manufacturing a profile corrugated tube in accordance with the fourth aspect, the sheet-formed molded body is continuously supplied by the supplying portion and the plural pairs of metal molds are moved over the moving track to take the receiving postures in the upstream position of the tube molding path and to take the molding postures in the downstream position thereof. Therefore, it is possible to manufacture the flat profile corrugated tube by continuously receiving the sheet-formed molded body supplied from the supplying portion through the plural pairs of metal molds and sequentially changing the postures of each pair of metal molds into the molding postures. In other words, a flat profile corrugated tube having a high elongation ratio can be manufactured continuously.

According to the device for manufacturing a profile corrugated tube in accordance with the fifth aspect, the guided portion is guided by the guiding rail; consequently, it is possible to move the pair of metal molds while changing the postures into the receiving postures and the molding postures. Thus, it is possible to move the pair of metal molds while changing the postures with a simple structure.

According to the method for manufacturing a profile corrugated tube in accordance with the sixth aspect, the molten resin is pushed out and supplied in the form of the sheet and the sheet-formed molded body thus supplied is molded into such a shape that the profile corrugated tube is broken and opened, and the molded body taking such a shape that the corrugated tube is broken and opened is then closed so that a profile corrugated tube is manufactured. Therefore, the sheet-formed molded bodies which tend to be deformed immediately after the supply can be prevented from being deformed and sticking together. Consequently, it is possible to manufacture a flat profile corrugated tube having a high elongation ratio.

According to the profile corrugated tube in accordance with the seventh aspect, the dimension in the long direction seen on the section is set to be three times as large as the dimension in the short direction or more. Therefore, the profile corrugated tube is suitable for a protecting member of a wire harness taking a flat shape and having a smaller thickness dimension than a width dimension, and can also be provided in a space having a small width in a more compact configuration.

### BRIEF DESCRIPTION OF DRAWINGS

FIG. 1 is a perspective view showing a profile corrugated tube according to an embodiment.

FIG. 2 is a schematic plan view showing a device for manufacturing the profile corrugated tube according to the embodiment.

FIG. 3 is a plan view showing a pair of metal molds taking a receiving posture.

FIG. 4 is a front view showing the pair of metal molds in a position A of FIG. 2.

FIG. 5 is a front view showing the pair of metal molds in a position B of FIG. 2.

FIG. 6 is a front view showing the pair of metal molds in a position C of FIG. 2.

FIG. 7 is a front view showing another molding posture.

FIG. 8 is a view showing an adhesion molding portion.

### EMBODIMENT FOR CARRYING OUT THE INVENTION

Description will be given to a profile corrugated tube, a device for manufacturing a profile corrugated tube and a method for manufacturing a profile corrugated tube according to an embodiment.

<Profile Corrugated Tube>

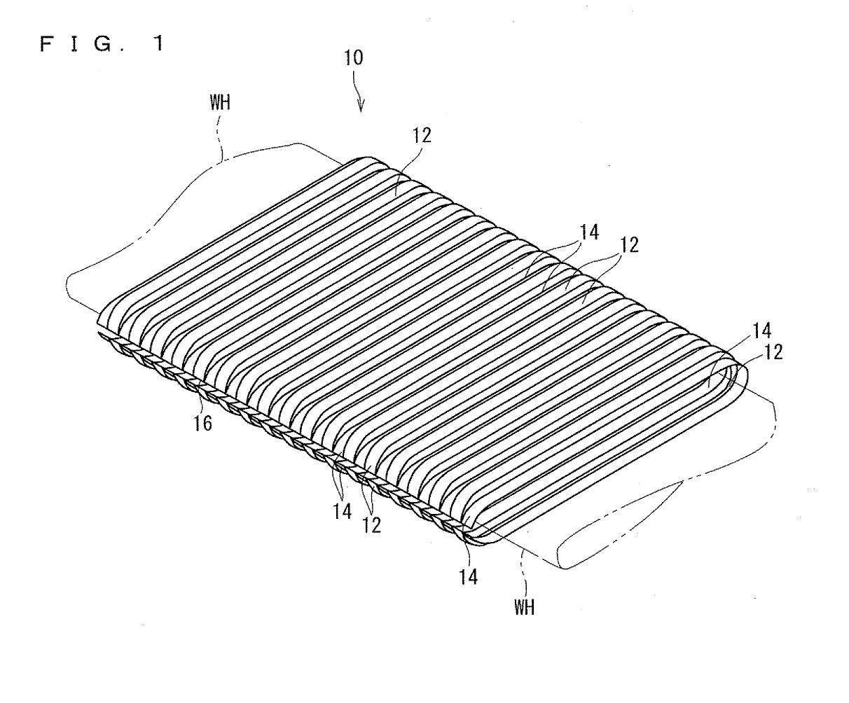

First of all, a profile corrugated tube 10 will be described (see FIG. 1). The profile corrugated tube 10 is a cylindrical member to be used as an outer casing member or the like which serves to protect a wire harness (WH) to be provided in a car or the like. Description will be given by taking an example in which the profile corrugated tube 10 is the outer casing member for protecting the wire harness (WH).

The profile corrugated tube 10 according to the present embodiment is a flat profile corrugated tube which is obtained by almost crushing a profile corrugated tube taking a circular shape seen on a section. A sectional shape of the flat profile corrugated tube 10 includes an elliptical shape, a shape obtained by rounding corners of a rectangle, a shape having a curved short side of a rectangle which is outward convex, and the like. In other words, the profile corrugated tube 10 takes a shape which is long in one direction and is short in an orthogonal direction thereto as seen on a section. In the profile corrugated tube 10 seen on the section, a direction having a large dimension will be referred to as a long direction and a direction having a small dimension will be referred to as a short direction in contrast to the long direction. Moreover, a dimension ratio of the dimension in the long direction to the dimension in the short direction in an inner peripheral part (an inner peripheral part of a concave portion 14 which will be described below) will be referred to as an elongation ratio,

Such a profile corrugated tube 10 is suitable for protecting a wire harness WH taking a flat shape. In other words, the wire harness WH also has a portion taking a flat shape in which a plurality of electric wires is bundled in parallel. For example, the wire harness WH taking the flat shape is used in a place having a small disposition space, for example, between a motor and a battery in a hybrid car, an electric car or the like in some cases.

More specifically, the profile corrugated tube 10 is formed to take a flat cylindrical shape in which a convex portion 12 and the concave portion 14 that are formed in a circumferential direction are continuously provided alternately in an extending direction. The profile corrugated tube 10 has an elongation ratio set to be three times or more. FIG. 1 shows the profile corrugated tube 10 having the elongation ratio set to be approximately eight times. By such a flat shape, the profile corrugated tube 10 is deformed in the long direction with difficulty and tends to be deformed in the short direction.

Herein, the profile corrugated tube 10 takes such a shape that the convex portion 12 and the concave portion 14 are flush with each other (are positioned over a straight line in the extending direction of the profile corrugated tube 10) at both ends in the long direction (see FIGS. 1, 6 and 7). More specifically, the convex portion 12 and the concave portion 14 are formed in such a manner that a difference between distances with respect to a central axis of the corrugated tube 10 (a difference in elevation between the convex portion 12 and the concave portion 14) is gradually reduced toward the end in a portion at the end side in the long direction. Moreover, the profile corrugated tube 10 takes a shape in which a sectional shape is a curved line with a short side of a rectangle set to be outward convex, that is, a shape having an almost straight portion in the long direction at both ends in the short direction.

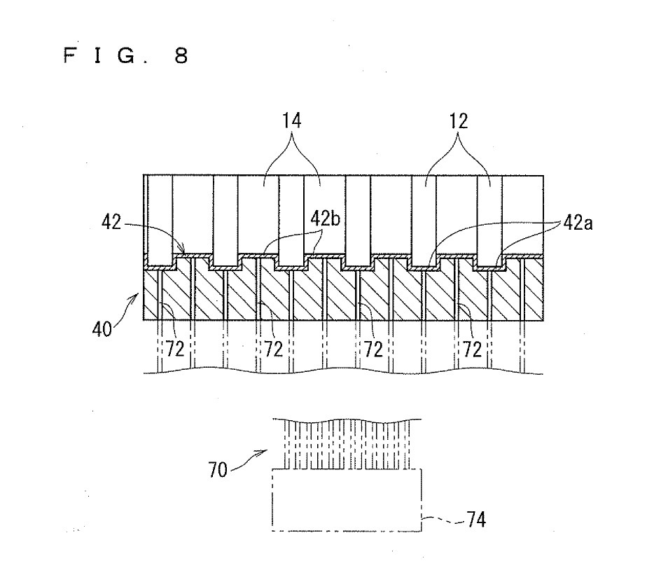

Moreover, the profile corrugated tube 10 has a slit 16 formed in the extending direction of the profile corrugated tube 10 at one of the ends in the long direction. The slit 16 serves to dispose the wire harness WH in the profile corrugated tube 10. It is preferable to dispose the wire harness WH in the profile corrugated tube 10 through the slit 16 and to use the slit 16 as an outer casing member for protecting the wire harness WH by carrying out tape wrapping or the like so as to be closed. The profile corrugated tube 10 does not need to have the slit 16 (see FIG. 7). In other words, it may take a non-end circular shape seen on a section.

The profile corrugated tube 10 is formed by carrying out metallic molding over a resin material 8 such as Nylon (registered trademark) or an olefin resin (polyethylene, polypropylene or the like).

According to the profile corrugated tube 10, the short dimension is set to be smaller than the long dimension. For this reason, from a viewpoint of the shape of the wire harness WH, also even in the case in which the wire harness WH taking a flat shape and having a smaller thickness dimension than a width dimension is a protecting target, the profile corrugated tube 10 taking a shape having a high elongation ratio which is more suitable for the shape is set to have a small clearance between an inner peripheral part thereof and an outer peripheral part of the wire harness WH, thereby enabling a suppression in a backlash. From a viewpoint of the disposition space, moreover, the profile corrugated tube 10 can have a small short dimension and can also be disposed in a space having a smaller width also in the case in which the wire harness WH having a great width dimension is protected.

<Device for Manufacturing Profile Corrugated Tube>

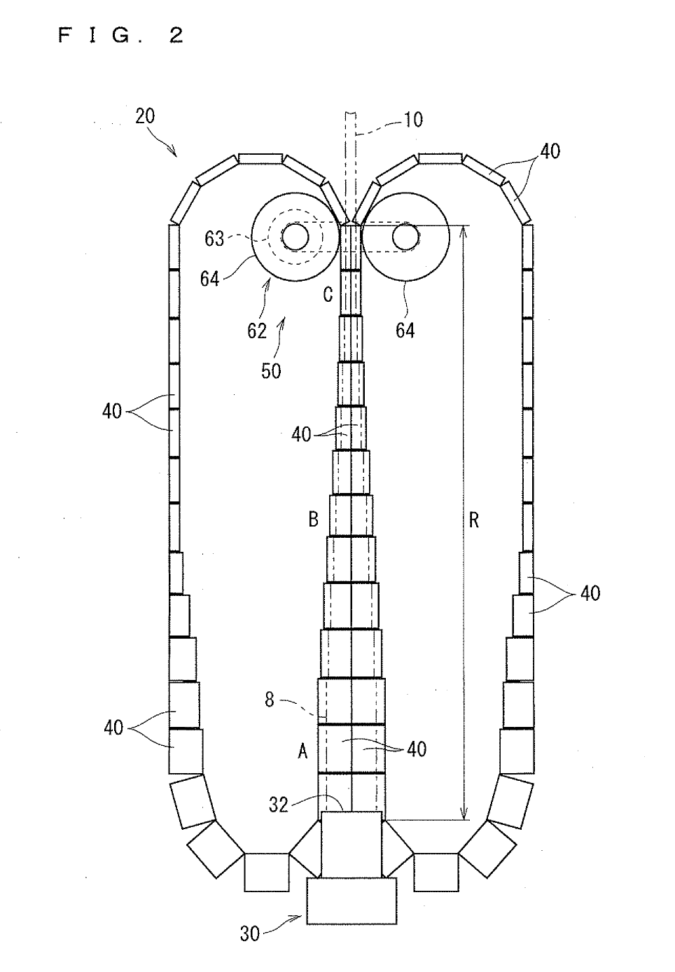

Next, description will be given to a device 20 for manufacturing a profile corrugated tube which serves to manufacture the flat profile corrugated tube 10. The device 20 for manufacturing a profile corrugated tube includes a supplying portion 30, plural pairs of metal molds 40, a driving mechanism portion 50 and an adhesion molding portion 70 (see FIG. 2 and FIG. 8 for the adhesion molding portion 70).

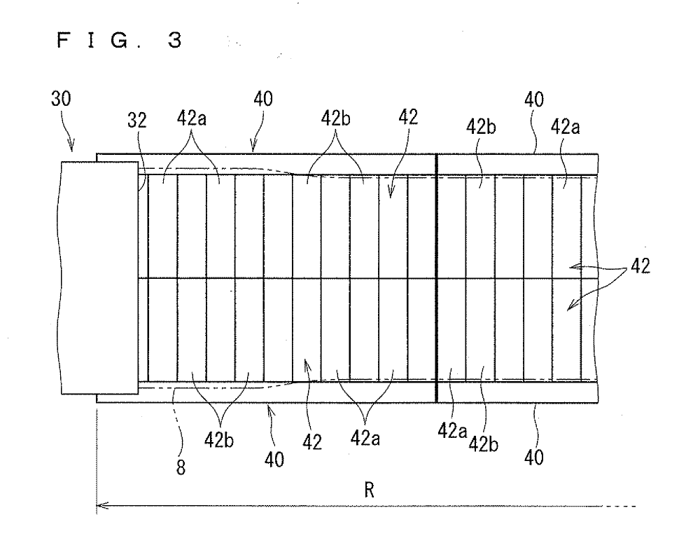

The supplying portion 30 is constituted to push out and supply the molten resin material 8 in the form of a sheet (see FIGS. 2 and 3). The supplying portion 30 is an extruding machine, and pushes out the molten resin material 8 via a T die (a flat die) 32 on a tip and molds the molten resin material 8 in the form of a sheet. The supplying portion 30 serves to supply a sheet-formed molded body (the resin material 8) in a softening state. It is assumed that the softening state indicates a harder state than a melting state (a fluidization is performed with difficulty) and a soft state in such a manner that molding can be carried out before a coagulation. The sheet-formed resin material 8 obtained immediately after a supply from the supplying portion 30 is deformed very easily in a soft state brought immediately after a reduction in a temperature is started from the melting state in the softening state. FIG. 4 shows, in a two-dotted chain line, the resin material 8 supplied in the form of a sheet above the pair of metal molds 40.

In the supplying portion 30, the T die 32 is provided in such a posture as to push out the resin material 8 in the form of an almost parallel sheet with respect to a horizontal plane. In the following description, a position of a tip portion of the T die 32 is referred to as a supplying position of the supplying portion 30 in some cases.

Herein, the sheet-formed molded body (the resin material 8) to be supplied by the supplying portion 30 is set to have a greater width dimension than an interval between edge portions in one of (outer) the metal mold surfaces 42 in the pair of metal molds 40 taking a receiving posture which will be described below (see FIGS. 3 and 4). In other words, the dimension is set in consideration of a prevention of the sheet-formed molded body from being lacked at an outside (in one of the edge portions) when it is to be closely deformed by a gravity with respect to the metal mold surfaces 42 of the pair of metal molds 40 and is to be caused to adhere by the adhesion molding portion 70. As shown in a right side of FIG. 3 and FIG. 4, consequently, it is possible to obtain a state in which the resin material 8 is caused to adhere to one of the edge portions of the metal mold surface 42, that is, the whole metal mold surface 42 when the resin material 8 is to be caused to adhere to the metal mold surface 42.

Moreover, the supplying portion 30 is constituted to continuously enable the supply of the sheet-formed molded body (the resin material 8). In other words, the supplying portion 30 continuously pushes out the molten resin material 8 in the form of a sheet and thus supplies the same.

The pair of metal molds 40 are metal molds for molding the profile corrugated tube 10 including metal mold surfaces having corresponding parts to one side portion in the long direction seen on the section of the profile corrugated tube 10, respectively. Referring to the pair of metal molds 40, the long direction and the short direction will be hereinafter used as a direction corresponding to the shape of the profile corrugated tube 10 in some cases.

The metal mold surface 42 corresponds to a shape obtained by dividing the profile corrugated tube 10 into two parts at both ends in the long direction seen on the section. Herein, the metal mold surface 42 has an almost straight part seen on a section in the long direction at an end in the short direction as a part corresponding to a side portion in the long direction seen on the section of the profile corrugated tube 10 (see FIG. 4). Moreover, the metal mold surface 42 has a curved part seen on the section corresponding to a curved part at both end sides in the long direction seen on the section of the profile corrugated tube 10 in succession to both sides of the almost straight part seen on the section. When the pair of metal molds 40 are butted with each other in such a posture as to oppose the metal mold surfaces 42 to each other, each of the metal mold surfaces 42 constitutes a surface corresponding to the shape of the profile corrugated tube 10.

The metal mold surface 42 is a concave surface having a convex portion forming surface 42a and a concave portion forming surface 42b which are alternately provided continuously in one direction (see FIGS. 3, 4 and 8). The convex portion forming surface 42a is a concave surface which is concaved toward an outer peripheral side, and the concave portion forming surface 42b is a convex surface which is convexed toward an inner peripheral side. The convex portion forming surface 42a and the concave portion forming surface 42b are almost flush with each other (the convex portion forming surface 42a and the concave portion forming surface 42b are positioned on a straight line in a continuous direction) in a corresponding part to both ends in the long direction seen on the section of the profile corrugated tube 10. In other words, the portion described above takes such a shape as to have no difference in elevation between the convex portion forming surface 42a and the concave portion forming surface 42b (a distance between inner and outer directions is almost zero). More specifically, the difference in elevation between the convex portion forming surface 42a and the concave portion forming surface 42b (the distance in the inner and outer directions) is gradually reduced toward ends in both end side portions in the long direction.

The other edge portion of the metal mold surface 42 is positioned on each of the other ends of the pair of metal molds 40 in the long direction (see FIGS. 3 and 4). In other words, when the pair of metal molds 40 are adjacent to each other in such a posture as to butt the other ends, the other edge portions of the metal mold surfaces 42 are adjacent to each other.

Herein, plural pairs of metal molds 40 are prepared and have the same shape. The pair of metal molds 40 have the convex portion forming surface 42a provided on one of ends and the concave portion forming surface 42b provided on the other end in one direction in which the convex portion forming surface 42a and the concave portion forming surface 42b are arranged. In other words, when the plural pairs of metal molds 40 are arranged in the one direction, the convex portion forming surface 42a and the concave portion forming surface 42b are arranged alternately also between the plural pairs of metal molds 40.

The driving mechanism portion 50 is constituted to enable a change in the posture of the pair of metal molds 40 into a receiving posture capable of opening the metal mold surfaces 42 (in an upward direction) to receive a sheet-formed molded body (the resin material 8) supplied from the supplying portion 30 and a molding posture in which the metal mold surfaces 42 are closed (see FIGS. 2 and 4 to 7). Moreover, the driving mechanism portion 50 serves to change the postures of the pair of metal molds 40 into the molding postures after the sheet-formed molded body supplied from the supplying portion 30 is received by the pair of metal molds 40 taking the receiving postures.

More specifically, the driving mechanism portion 50 moves the plural pairs of metal molds 40 in series over a pair of moving tracks taking a non-end circular shape, respectively. In a predetermined tube molding path R of the moving track, the postures of the pair of metal molds 40 are gradually changed from an upstream of a tube molding path R through which the sheet-formed molded body is supplied from the supplying portion 30 toward a downstream thereof in such a manner as to cause the pair of metal molds 40 to take the receiving postures in an upstream position of the tube molding path R and while causing the pair of metal molds 40 to take the molding postures in a downstream position of the tube molding path R (see FIG. 2). The tube molding path R is extended in a supply direction in a lower position of the supplying portion 30 and the upstream position is placed in a supply position of the supplying portion 30 as seen on a plane (see FIG. 3).

The receiving postures of the pair of metal molds 40 indicate a posture in which the respective metal mold surfaces 42 are turned in an upward direction and the respective metal mold surfaces 42 are adjacent to each other (may be provided in contact with each other) in the other edge portions. For this reason, when the sheet-formed molded body (the resin material 8) is supplied onto each of the metal mold surfaces 42 of the pair of metal molds 40 taking the receiving posture, the sheet-formed molded body is deformed toward the metal mold surface 42 by a dead weight. It is preferable that the receiving posture should be set to be a posture in which an almost straight portion seen on a section is positioned on an almost horizontal plane in each of the metal mold surfaces 42 (see FIG. 4). According to the receiving posture, the almost straight portion seen on the section of each metal mold surface 42 is almost parallel with the horizontal plane, and a direction of a gravity and a corresponding direction to the short direction of the profile corrugated tube 10 are almost coincident with each other. Therefore, the resin material 8 can come in contact with the metal mold surface 42 in a smaller deformation quantity (see FIG. 4).

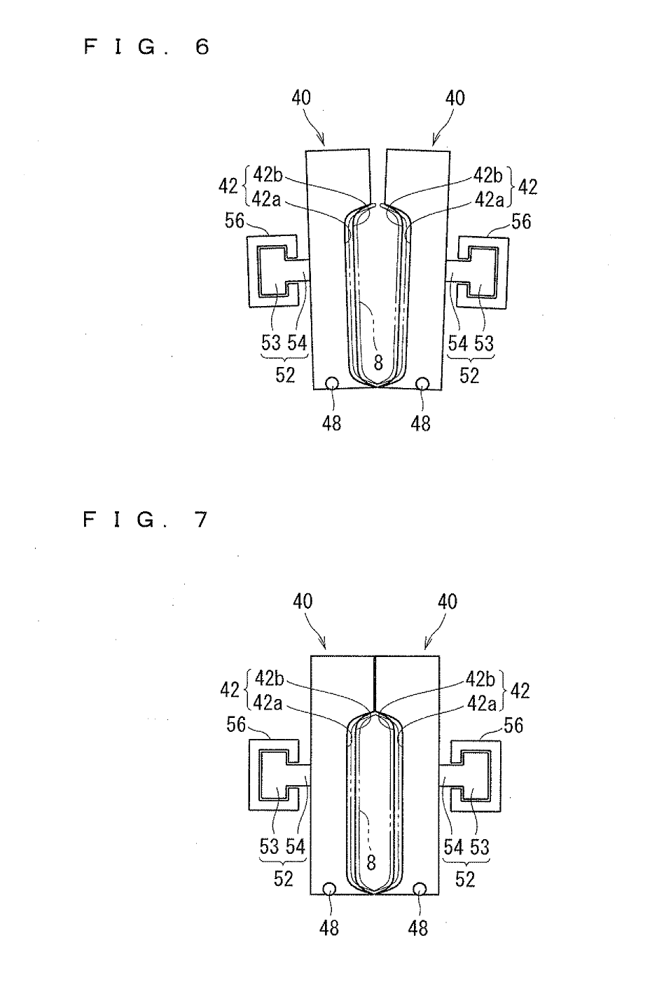

Moreover, the molding postures of the pair of metal molds 40 indicate a posture for molding the resin material 8 supplied onto the metal mold surface 42 into the shape of the profile corrugated tube 10 as a product. Herein, the molding posture indicates a posture in which the respective metal mold surfaces 42 of the pair of metal molds 40 form a predetermined interval from each other at one of the edge portions, and are butted with each other and are thus adjacent to each other (preferably comes in contact with each other) at the other edge portion (see FIG. 6). In other words, in the case in which the pair of metal molds 40 are caused to take the molding posture, it is possible to obtain the profile corrugated tube 10 provided with the slit 16 opened at one of the ends in the long direction seen on the section. The profile corrugated tube 10 thus obtained has no cutting trace as in the case in which a slit is formed by cutting. However, the molding postures of the pair of metal molds 40 are not restricted thereto but may be a posture in which both edge portions of each of the metal mold surfaces 42 are caused to be adjacent to each other in the case in which the profile corrugated tube having no slit 16 is manufactured (see FIG. 7).

A specific structure of the driving mechanism portion 50 will be described. The driving mechanism portion 50 has a guided portion 52, a pair of guiding rails 56 and a feeding portion 62 (see FIGS. 2 and 4 to 7).

The guided portion 52 is a member for moving the metal mold 40 along the guiding rails 56 and is attached to each of the plural pairs of metal molds 40. More specifically, the guided portion 52 has a fitting portion 53 to be fitted in the guiding rail 56 and a support portion 54 for supporting the metal mold 40 (see FIGS. 4 to 7). The support portion 54 is fixed to the metal mold 40 in a part on an opposite side to the metal mold surface 42 (an almost center) at a base end thereof. Moreover, the fitting portion 53 is linked to a tip part side of the support portion 54 and is formed to take a larger sectional area than that of the support portion 54. In other words, the guided portion 52 is formed to take an almost T shape as a whole.

The pair of guiding rails 56 are members for guiding the plural pairs of metal molds 40 along a moving track in a state in which the guided portions 52 are fitted respectively. The guiding rail 56 is opened at one of parts and is formed to take an almost C shape seen on a section which has a wider internal space than an opening portion 57 at an inner side of the opening portion 57.

The guided portion 52 attached to each of the metal molds 40 is fitted in each of the pair of guiding rails 56 in such a manner that each of the metal molds 40 is supported. The metal molds 40 are provided to be arranged in the form of a non-end circle adjacently with respect to the guiding rails 56. The guided portion 52 is fitted in the guiding rail 56 in such a posture that one direction in which the convex portion forming surface 42a and the concave portion forming surface 42b in the metal mold 40 are continuous is almost identical to the extending direction of the guiding rail 56. The metal molds 40 may be moved as a whole through a sequential abutment on each other or the metal molds 40 or the guided portions 52 may be moved in a coupling state through a coupling member which is not shown.

The pair of guiding rails 56 are provided along the moving track and are formed to take a twisted shape in which the guided portion 52 can be guided to change the postures of the pair of metal molds 40 from the receiving posture to the molding posture over the tube molding path R. More specifically, the pair of metal molds 40 are caused to take the receiving posture (see FIG. 4) in the upstream position of the tube molding path R (the supply position of the supplying portion 30), and furthermore, one of the edge portions of the metal mold surface 42 is caused to be gradually close with the other edge portions set to be adjacent each other and to take the molding posture (see FIG. 6) in the downstream position of the tube molding path R. Moreover, the pair of guiding rails 56 are formed to separate the pair of metal molds 40 from each other in a moving track other than the tube molding path R and to change the posture of each of the metal molds 40 in order to take the receiving posture in the upstream position of the tube molding path R. FIGS. 4 to 6 show the postures of the pair of metal molds 40 in positions A to C in FIG. 2, respectively.

In other words, the pair of guiding rails 56 take such a shape that the opening portions 57 are turned upward in the upstream position of the tube molding path R and are gradually tilted, and are opposed to each other in the downstream position of the tube molding path R (herein, are tilted toward a slightly upper side) and are gradually turned upward toward the upstream position of the tube molding path R again.

The feeding portion 62 is a mechanism for feeding the metal molds 40 so as to be moved over the moving track in the supply direction of the supplying portion 30, that is, a direction from the upstream toward the downstream in the tube molding path R. For example, it is possible to employ, as the feeding portion 62, a structure in which a pair of gears 64 to be rotated and driven synchronously by means of a motor 63 are provided in predetermined positions over the respective moving tracks and a protruded portion (not shown) capable of being engaged with each of the gears 64 is provided on each of the metal molds 40, and the respective gears 64 to be rotated and driven are engaged with the protruded portions of the respective metal molds 40 to feed the metal molds 40 (see FIG. 2). In FIG. 2, a timing belt for synchronizing the pair of gears 64 is shown in a broken line. Moreover, a feeding roller may be employed in place of the gear and be provided in contact with the metal mold 40. However, the feeding portion 62 is not restricted to the structure described above but can preferably feed the pairs of metal molds 40 in predetermined directions of the moving tracks respectively, and other various structures can be employed.

The postures of the pairs of metal molds 40 to be moved by the driving mechanism portion 50 are gradually changed in such a state as to have the resin material 8 on the metal mold surfaces 42 or between them in the tube molding path R, respectively. In the tube molding path R, thus, the pairs of metal molds 40 which are arranged can take different postures sequentially. For this reason, it is preferable to reduce a shift between the metal mold surfaces 42 of a sequential pair of metal molds 40 due to a difference in the posture. Therefore, it is preferable that the driving mechanism portion 50 should set a twist of the pair of guiding rails 56 (the opening portions 57) to be gentler in order to change the postures of the pair of metal molds 40 more moderately.

Moreover, the driving mechanism portion 50 has such a structure as to move the pair of metal molds 40 in the receiving posture in a predetermined distance including the upstream position of the tube molding path R (see FIGS. 2 and 3). In other words, the pair of guiding rails 56 are caused to take an almost straight shape (having no twist) at the predetermined distance including the upstream position. This is a structure for maintaining, without sticking, the resin material 8 which tends to be deformed more easily immediately after the supply and causing the resin material 8 to adhere to the metal mold surface 42 more reliably.

Furthermore, the driving mechanism portion 50 is constituted to move the pair of metal molds 40 in the molding posture at the predetermined distance including the downstream position of the tube molding path R (see FIG. 2). In other words, the pair of guiding rails 56 are caused to take an almost straight shape (having no twist) at the predetermined distance including the downstream position. This is a structure for bringing the resin material 8 to be molded in a softening state into a coagulation state in which it is so hard as to maintain a shape independently.

The adhesion molding portion 70 has such a structure as to cause the resin material 8 supplied in the form of a sheet from the supplying portion 30 to adhere to the respective metal mold surfaces 42 of the pair of metal molds 40 taking the receiving posture (see FIG. 8).

Herein, the adhesion molding portion 70 employs a structure using a vacuum molding method. The vacuum molding method serves to suck the resin material 8 supplied onto the metal mold surfaces 42 of the metal molds 40 from the metal mold surface side 42, thereby causing the resin material 8 to adhere to the metal mold surface 42 and carrying out molding into the shape of the metal mold surface 42. The adhesion molding portion 70 has such a structure that a plurality of sucking holes 72 penetrating through an inside of the metal mold surface 42 and an outside of the metal mold 40 is formed on the pair of metal molds 40 and air on the inside of the metal mold surface 42 is sucked via the sucking hole 72 by means of a sucking device 74. The sucking holes 72 are formed to be opened on the convex portion forming surface 42a and the concave portion forming surface 42b, respectively. When the air is sucked through each of the sucking holes 72 in a state in which the sheet-formed resin material 8 is supplied to the pair of metal molds 40 taking the receiving posture, the air between the sheet-formed resin material 8 and the metal mold surface 42 is sucked so that the resin material 8 is caused to adhere to the metal mold surface 42. Herein, the suction is set to be carried out in the pair of metal molds 40 for a period of a movement in the tube molding path R. The sucking period represents a duration for which at least the resin material 8 on the metal mold surface 42 (or between the metal mold surfaces 42) is caused to wholly adhere to the metal mold surface 42 and becomes hard due to such a reduction in a temperature that an adhesion shape to the metal mold surface 42 is maintained also in a non-sucking state.

In order to suppress in a leakage of the air from a portion between the pair of metal molds 40 (the other edge portions of the metal mold surfaces 42) when the suction is carried out by the adhesion molding portion 70, moreover, an airtight member 48 is provided (see FIGS. 4 to 7). More specifically, the airtight member 48 is formed by a rubber or a resin material which can be elastically deformed. The airtight member 48 is provided to be protruded (herein, to be slightly protruded) from each of the other end faces of the pair of metal molds 40, and is set into a state in which it is elastically deformed in an abutment in the receiving postures of the pair of metal molds 40. Consequently, it is possible to suppress the air leakage from the portion between the metal molds 40 on the metal mold surface 42 side of the pair of metal molds 40 and an opposite side thereto.

However, the adhesion molding portion 70 is not restricted to the structure using the vacuum molding method. For example, it is possible to employ a structure for jetting compressed air toward the metal mold surfaces 42 of the pair of metal molds 40 taking the receiving posture from an upper part thereof. In other words, with the structure, the compressed air is jetted onto the sheet-formed resin material 8 supplied onto the pair of metal molds 40 taking the receiving posture, and the resin material 8 is deformed to be pushed against the metal mold surfaces 42 and is thus caused to adhere to the metal mold surfaces 42. In addition, it is possible to employ a structure for causing a female metal mold surface of a female metal mold corresponding to each of the pair of metal molds 40 to approach each of the pair of metal molds 40 taking receiving posture, thereby causing the resin material 8 to adhere to the metal mold surface 42. For example, it is preferable to cause the resin material 8 to sequentially adhere to the metal mold surface 42 by a structure for rotating, around an axis, a female metal mold having a female metal mold surface formed around the axis or moving the female metal mold upward and downward.

Moreover, the device 20 for manufacturing a profile corrugated tube is not restricted to the structure for changing the posture while moving the pair of metal molds 40. In other words, it is also possible to employ a structure for supplying the sheet-formed molded body (the resin material 8) onto the pair of metal molds 40 taking the receiving posture and having a predetermined length by means of the supplying portion 30 and then changing the postures of the pair of metal molds into the molding postures without a movement.

<Method for Manufacturing Profile Corrugated Tube>

Next, a method for manufacturing the profile corrugated tube 10 will be described by taking an example in which the device 20 for manufacturing a profile corrugated tube is used. It is assumed that the plural pairs of metal molds 40 are moved along the moving track by means of the driving mechanism portion 50.

First of all, the molten resin material 8 is pushed out and supplied in the form of a sheet (step (a), see the resin material 8 shown in a two-dotted chain line at an upper side of FIG. 4). More specifically, the molten resin material 8 is pushed out in the form of the sheet through the T die 32 by the supplying portion 30 and is supplied in a softening state in which a temperature is lower than that in a melting state. The sheet-formed molded body (the resin material 8) thus supplied is put on the pair of metal molds 40 taking the receiving posture which is placed in the upstream position of the tube molding path R in a state in which it is suspended onto the metal mold surface 42 by an influence of a gravity and partially comes in contact with the metal mold surface 42. Then, the sheet-formed molded body is continuously supplied from the supplying portion 30 and is put on the plural pairs of metal molds 40 to be moved from the upstream toward the downstream in the tube molding path R.

Next, the sheet-formed molded body supplied in step (a) is formed to take such a shape that the profile corrugated tube 10 is broken and opened at one of ends in a long direction seen on a section (step (b)). More specifically, air in a portion between the resin material 8 and the metal mold surface 42 is sucked through each sucking hole 72 by means of the adhesion molding portion 70 using the vacuum molding method so that the resin material 8 is caused to adhere to the metal mold surface 42 (see FIGS. 4 and 8). The sheet-formed resin material 8 is deformed to approach the metal mold surface 42 by the influence of the gravity.

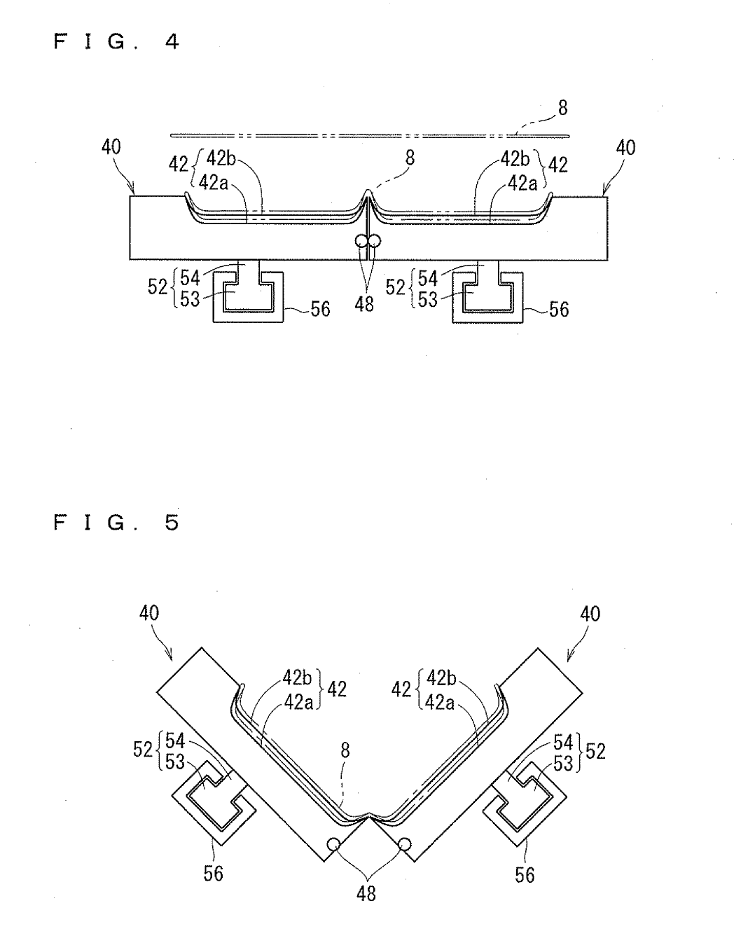

Then, there is closed the molded body formed in step (b) and taking the shape in which the profile corrugated tube 10 is broken and opened (step (c)). In other words, when the postures of the pair of metal molds 40 are gradually changed into the molding postures with the movement from the upstream to the downstream in the tube molding path R, the resin material 8 is deformed in such a manner that portions corresponding to one of the ends in the long direction seen on the section of the profile corrugated tube 10 gradually approach each other (see FIG. 5). Also in this state, the resin material 8 is maintained in the softening state with a gradual reduction in a temperature. Herein, the temperature of the resin material 8 is reduced in contact with the metal mold 40 or the air.

When the postures of the pair of metal molds 40 are changed into the molding postures, furthermore, the resin material 8 takes the shape of the profile corrugated tube 10 as a product (see FIG. 6). In a state in which the pair of metal molds 40 are moved to the downstream side of the tube molding path R, the resin material 8 is brought into a coagulation state in which it is so hard as to capable of independently holding the shape.

When the pair of metal molds 40 are further moved from the downstream position of the tube molding path R, the metal mold surfaces 42 of the pair of metal molds 40 are separated from each other with respect to the outer peripheral portion of the profile corrugated tube 10 (see FIG. 2). Then, the finished profile corrugated tube 10 is fed toward the downstream side from the tube molding path R.

As described above, the profile corrugated tube 10 is manufactured.

In the case in which a profile corrugated tube having no slit 16 is manufactured, it is preferable to have such a structure that the postures of the pair of metal molds 40 are changed into the molding postures in which edge portions in one of the metal mold surfaces 42 of the pair of metal molds 40 are adjacent to each other with the resin materials 8 maintained in a softening state having such a high temperature that they stick together (see FIG. 7). In other words, it is possible to employ a structure in which a mechanism for heating the metal mold 40 is provided.

According to the device 20 for manufacturing a profile corrugated tube and the method for manufacturing a profile corrugated tube, there is employed the structure in which the molten resin material 8 is pushed out and supplied by the supplying portion 30 and the sheet-formed molded body (the resin material 8) supplied from the supplying portion 30 is received in the receiving posture, and the postures of the pair of metal molds 40 are then changed into the molding postures. In other words, the resin material 8 which tends to be deformed soon after the reduction in the temperature in the melting state immediately after the supply is supplied in such a sheet-formed shape that the resin materials 8 stick together with difficulty. Furthermore, the sheet-formed molded body to be supplied is received by the pair of metal molds 40 in the receiving posture in which the resin materials 8 stick together with difficulty. After the receipt in the receiving posture and the reduction in the temperature immediately after the supply, the postures of the pair of metal molds 40 are changed into the molding postures and are thus molded into the shape of the profile corrugated tube. For this reason, the resin materials 8 which have just been supplied are prevented from being bent and crushed by the influence of the gravity or sticking together; consequently, it is possible to manufacture the flat profile corrugated tube 10 which has a high elongation ratio.

Moreover, the molding postures of the pair of metal molds 40 are set into postures in which the respective metal mold surfaces 42 are provided at a predetermined interval in one of the edge portions. Without providing a slit forming step separately, consequently, it is possible to manufacture the flat profile corrugated tube 10 which has a slit 16 for accommodating a wire harness WH.

Moreover, the receiving postures of the pair of metal molds 40 are set into postures in which the respective metal mold surfaces 42 are turned upward. For this reason, it is possible to prevent the sheet-formed molded body (the resin material 8) supplied onto the pair of metal molds 40 taking the receiving posture from the supplying portion 30 from being deformed to approach the metal mold surfaces 42 by the influence of the gravity and being bent or crushed apart from the metal mold surfaces 42 or sticking together. Consequently, it is possible to manufacture the flat profile corrugated tube 10 which has a high elongation ratio more reliably.

Moreover, the sheet-formed molded body is continuously supplied by the supplying portion 30, and the plural pairs of metal molds 40 are moved over a pair of moving tracks respectively and are thus caused to take the receiving posture in the upstream position of the tube molding path R, and furthermore, are caused to take the molding posture in the downstream position thereof. Therefore, it is possible to manufacture the profile corrugated tube 10 by continuously receiving the sheet-formed resin material 8 supplied from the supplying portion 30 through the plural pairs of metal molds 40, thereby changing the posture of each of the pairs of metal molds 40 into the molding posture sequentially. In other words, it is possible to continuously manufacture the profile corrugated tube 10 having a high elongation ratio.

By guiding the guided portion 52 to the guiding rail 56 taking a twisted configuration, furthermore, it is possible to move the pair of metal molds 40 while changing the postures into the receiving postures or the molding postures. Thus, it is possible to move the pair of metal molds 40 while changing the postures with a simple structure.

<Referring to Manufacture of Profile Corrugated Tube having High Elongation Ratio>

Description will be given to a propriety of the manufacture of the flat profile corrugated tube 10 which has a different elongation ratio through an existing device for manufacturing a corrugated tube and the device 20 for manufacturing a profile corrugated tube according to the present invention.

The existing device for manufacturing a corrugated tube employs a structure using a vacuum molding method such as the adhesion molding portion 70 in place of a blow molding method in the device for manufacturing a corrugated tube which is disclosed in the Patent Document 1. In other words, with the structure, a molten resin material is cylindrically pushed out by an excluding machine and is thus supplied into a pair of closed metal molds forming a cylindrical molding space, and air is sucked from a metal mold surface side to cause a cylindrical molded body to adhere to the metal mold surface.

Herein, description will be given to the case in which a corrugated tube having no slit formed thereon is manufactured by using Nylon (registered trademark) as a resin material.

In the case in which the corrugated tube is manufactured by the existing device for manufacturing a corrugated tube, a profile corrugated tube having an elongation ratio of 2.5 or less can be molded in the same manner as a corrugated tube (an elongation ratio of one) taking a cylindrical shape; however, it is impossible to manufacture the profile corrugated tube 10 having an elongation ratio of three or more. The reason is supposed as follows: the molded body to be supplied from the extruding machine tends to be deformed very easily in a soft state immediately after a reduction in a temperature is started in a melting state, and furthermore, a portion in a long direction seen on a section is positioned at a small interval in a short direction; consequently, the portions in the long direction of the molded body immediately after the supply stick together. In other words, in such a case, it is impossible to mold the resin material into the shape of the corrugated tube without an adhesion to the metal mold surface.

On the other hand, in the device 20 for manufacturing a profile corrugated tube, the molded body (the resin material 8) supplied from the supplying portion 30 is set into a soft state brought immediately after the reduction in the temperature is started in the melting state; however, after the molded body is supplied in the form of a sheet and is received by the pair of metal molds 40 taking the receiving posture, the postures of the pair of metal molds 40 are changed into the molding postures and molding is thus carried out. In other words, in the soft state brought immediately after the supply, the resin material 8 has no portions opposed at a small interval and is then molded into the shape of the profile corrugated tube 10 in a state in which the temperature is further reduced and the resin material 8 is harder than that obtained immediately after the supply due to the reduction in the temperature (a state in which the resin material 8 has such a softness as to be moldable). Referring to the receiving postures of the pair of metal molds 40, similarly, the sheet-formed molded body to be supplied is deformed to approach the metal mold surfaces 42 by the influence of the gravity. Therefore, it is possible to prevent the resin materials 8 from sticking together by a deformation in a softer state immediately after the supply. Consequently, the resin material 8 can be caused to reliably adhere to the metal mold surface 42 by the adhesion molding portion 70; thus, it is possible to mold the resin material 8 into the shape of the profile corrugated tube 10.

As described above, according to the device 20 for manufacturing a profile corrugated tube, it is supposed that the problems of the existing device for manufacturing a corrugated tube can be solved and the flat profile corrugated tube 10 having an elongation ratio of three or more which is hard to manufacture by the existing device for manufacturing a corrugated tube can also be manufactured.

Although the profile corrugated tube 10, the device 20 for manufacturing a profile corrugated tube and the method for manufacturing a profile corrugated tube have been described above in detail, the description is only illustrative in all aspects and the present invention is not restricted thereto. It is to be understood that numerous variants which are not illustrated can be devised without departing from the scope of the present invention.

### EXPLANATION OF DESIGNATION

10 profile corrugated tube

12 convex portion

14 concave portion

16 slit

20 device for manufacturing profile corrugated tube

30 supplying portion

40 metal mold

42 metal mold surface

50 driving mechanism portion

70 adhesion molding portion

WH wire harness

1. A device for manufacturing a profile corrugated tube which serves to manufacture a flat profile corrugated tube, comprising:
a supplying portion for pushing out and supplying a molten resin in the form of a sheet;
a pair of metal molds for molding a profile corrugated tube which include metal mold surfaces having corresponding portions to one side portion in a long direction seen on a section of said profile corrugated tube, respectively;
a driving mechanism portion capable of changing postures of said pair of metal molds into a receiving posture in which said metal mold surfaces are opened and can receive a sheet-formed molded body supplied from said supplying portion and a molding posture in which said metal mold surfaces are closed, and changing the postures of said pair of metal molds into said molding postures after said sheet-formed molded body supplied from said supplying portion is received by said pair of metal molds taking said receiving postures; and
an adhesion molding portion for causing said sheet-formed molded body supplied from said supplying portion to adhere to said metal mold surfaces of said pair of metal molds taking said receiving postures.

2. The device for manufacturing a profile corrugated tube according to claim 1, wherein the molding postures of said pair of metal molds are postures in which said respective metal mold surfaces form a predetermined interval in one of edge portions and are adjacent to each other in the other edge portion.

3. The device for manufacturing a profile corrugated tube according to claim 1, wherein the receiving postures of said pair of metal molds are postures in which said respective metal mold surfaces are turned upward and are adjacent to each other in the other edge portion.

4. The device for manufacturing a profile corrugated tube according to claim 1, wherein said supplying portion can continuously supply said sheet-formed molded body, and
said driving mechanism portion moves said plural pairs of metal molds in series over a pair of non-end circular moving tracks respectively, and gradually changes the postures of said pair of metal molds from an upstream toward a downstream in order to cause said pair of metal molds to take the receiving postures in an upstream position of a predetermined tube molding path in said moving track through which said sheet-formed molded body is supplied from said supplying portion and to cause said pair of metal molds to take the molding postures in a downstream position of said tube molding path in said tube molding path.

5. The device for manufacturing a profile corrugated tube according to claim 1, wherein said driving mechanism portion includes:
a guided portion attached to each of said plural pairs of metal molds;
a pair of guiding rails provided along said moving track and formed to take such a shape that said guided portion can be guided to change the postures of said pair of metal molds from the receiving postures to the molding postures over said tube molding path; and
a feeding portion for feeding said plural pairs of metal molds so as to be moved from said upstream toward said downstream in said tube molding path.

6. A method for manufacturing a profile corrugated tube which serves to manufacture a flat profile corrugated tube, comprising the steps of
(a) pushing out and supplying a molten resin in the form of a sheet;
(b) molding said sheet-formed molded body supplied at said step (a) into a shape in which said profile corrugated tube is broken and opened at one of ends in a long direction seen on a section; and
(c) closing said molded body molded at said step (b) and taking said shape in which said profile corrugated tube is broken and opened.

7. A flat profile corrugated tube wherein a sheet-formed molded body obtained by pushing out and supplying a molten resin in the form of a sheet is molded into such a shape that a finished profile corrugated tube is broken and opened at one of ends in a long direction seen on a section and the molded body taking such a shape that said finished profile corrugated tube is broken and opened is closed, and
a dimension in the long direction seen on the section is set to be three times as large as a dimension in a short direction or more.
